(19) United States
(12) Patent Application Publication
(10) Pub. No.: US 2009/0187640 A1
(43) Pub. Date: Jul. 23, 2009

(54) IN-FLIGHT INFORMATION SYSTEM

(75) Inventors: Wayne M. Delia, Poughkeepsie, NY (US); Edward E. Kelley, Wappingers Falls, NY (US); Franco Motika, Hopewell Junction, NY (US)

Correspondence Address: Cantor Colburn LLP - IBM Endicott, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/018,505

(22) Filed: Jan. 23, 2008

(51) Int. Cl. G06F 15/16

(52) U.S. Cl. 709/219

(57) ABSTRACT

A system for implementing an in-flight passenger information system includes one or more ground-based servers in network communication with an airplane-based server, the one or more ground-based servers configured to execute a computer application for accessing a database containing airport infrastructure information and passenger transactional information; and the airplane-base server in communication with one or more passenger accessible input/output devices; wherein the one or more passenger accessible input/output devices are configured to communicate to a passenger, while onboard an airplane, passenger-selected portions of the airport infrastructure information and passenger transactional information specific to the passenger.

### BACKGROUND

The present invention relates generally to communications systems and, more particularly, to an in-flight passenger information system for communicating customized, detailed air travel information to passengers prior to departing an aircraft.

One problem often encountered by airline travelers is the lack of time and information needed upon arrival at either an interim or final destination airport terminal. This information may include, for example, transfer flight time schedule and logistic information for the particular airport. Additionally, there may be detailed information that applies only to individual passengers with no relevance to other passengers, such as individual flight itineraries and other personalized travel plans. For example, upon landing in Chicago, one passenger's connecting flight delay to Seattle would be of no interest to another passenger (on the same flight to Chicago) who is continuing on to Los Angeles. Connecting flight information is typically transmitted to the cockpit, where it is printed out and read only once over the airplane loudspeaker. Typically, no additional information is announced or otherwise made available to passengers during the flight, with the exception of perhaps from some physical layout diagrams of major airport terminals printed in airline magazines.

Information systems such as the Passenger Information Delivery System (PIDS) for reservations, the Flight Progress Event System (FPES) of Delta Airlines, and the Gate Information Display System all provide various types of dynamic, real time travel information. However, such systems generally operate within the confines of workstations, gate entry checkpoints, baggage handling checkpoints and other such locations with the airport itself. In other words, such systems and information are not directly accessible by passengers themselves on the airplanes in-flight (i.e., at a time prior to exiting the aircraft cabin). Moreover, such real-time information is still not segregated or customized to individual passengers.

### SUMMARY

The foregoing discussed drawbacks and deficiencies of the prior art are overcome or alleviated, in an exemplary embodiment, by a system for implementing an in-flight passenger information system, including one or more ground-based servers in network communication with an airplane-based server, the one or more ground-based servers configured to execute a computer application for accessing a database containing airport infrastructure information and passenger transactional information; and the airplane-base server in communication with one or more passenger accessible input/output devices; wherein the one or more passenger accessible input/output devices are configured to communicate to a passenger, while onboard an airplane, passenger-selected portions of the airport infrastructure information and passenger transactional information specific to the passenger.

In another embodiment, a computer program product includes a computer readable computer program code for implementing a method of accessing and operating an in-flight passenger information system; and instructions for causing a computer to implement a method, the method further including receiving a request for one or more of airport infrastructure information and passenger transactional information specific to a passenger onboard an airplane, the request being input by the passenger via one or more passenger accessible input/output devices; accessing, through one or more ground-based servers in network communication with an airplane-based server, a database containing the airport infrastructure information and the passenger transactional information; and communicating the requested information to the onboard passenger, received by the airplane-based server, through the one or more passenger accessible input/output devices.

### BRIEF DESCRIPTION OF THE DRAWINGS

Referring to the exemplary drawings wherein like elements are numbered alike in the several Figures:

FIG. 1 is a schematic block diagram illustrating an in-flight passenger information system, in accordance with an embodiment of the invention; and

FIGS. 2(a) and 2(b) are a flow diagram illustrating a method for operating an in-flight passenger information system, in accordance with a further embodiment of the invention.

### DETAILED DESCRIPTION

Disclosed herein is a system and method for providing an in-flight passenger information system for communicating customized, detailed air travel information to passengers prior to departing an aircraft, thereby facilitating their arrival and transfer to other flights. Briefly stated, the information is retrieved by the aircraft sub-system and broadcast to, for example, an existing overhead projection display within an aircraft, personal seat displays having interactive capability, and/or to personal communication devices of the passenger. This current and updated information may be transmitted, for example, by the local airport ground system support or each aircraft could request and retrieve the pertinent information from the airport approached by the aircraft. Where personal seat displays are available, the invention embodiments further establish the capability of individual passengers to access, display, and update information that affects their personal flight itinerary. Another contemplated embodiment makes the information available to individual passenger communication devices (e.g., cell phones, personal digital assistants (PDAs), etc.) by having the passengers enter personalized information such as their boarding pass security code number on the current flight.

The in-flight information communicated to the passengers may include, for example: flight arrival and departure times, similar to the information presently available in airport terminals; airport maps with gate information and luggage pickup areas; flight schedule changes, cancellations and delays; local weather information; security warnings; notices of overbooking of continuing flight segments (with offers to passengers on earlier flight legs the opportunity to change flights for a premium); current locations or estimated arrival times of luggage both on the plane and any items which may be delayed or misplaced.

In addition, the passenger information system is extended to include on-demand, personalized information retrieval keyed to passengers by (for example) their boarding pass security code number on the current flight. Where applicable, a conversion sub-system may be provided to format the airport terminal information to the aircraft's display video system.

As indicated above, an additional embodiment would include the same information transmitted to other personal devices such as a passenger's cell phone or PDA, which is made available after the flight captain has given the “all clear” is given to resume the use of personal electronic devices once the plane has landed. This would allow passengers to obtain desired information tailored to their itineraries without relying on display devices provided by the airline.

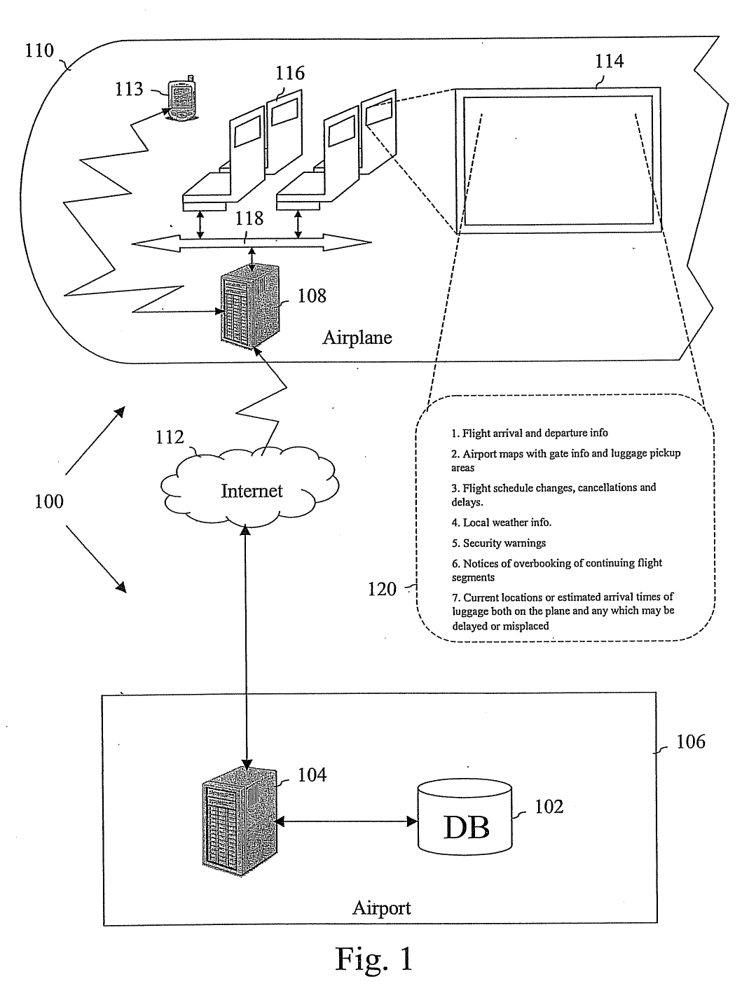

Referring initially to FIG. 1, there is a shown schematic block diagram illustrating an in-flight passenger information system 100, in accordance with an embodiment of the invention. The in-flight passenger system 100 is characterized by a computer application system with a database 102 of airport infrastructure information (e.g., airport terminal layouts, default flight schedules, etc.) as well as passenger transactional information (e.g., passenger identification, trip continuation flight legs for current passengers, gate information for connecting flights, baggage claim information for the current flight, local weather information, flight schedule changes, cancellations and delays, security warnings, overbooking premium opportunities, and baggage tracking and pickup information).

The application system is controlled at the airport air traffic control and logistics coordination centers, such as through one or more ground-based servers 104 associated with a destination airport 106. While the ground-based server may be physically located within the confines of the airport 106, this need not necessarily be the case. For example, additional servers that support the application may also be located “off-site.” In addition, client systems on airplanes (e.g., server 108 on airplane 110) are pre-loaded with both infrastructure information and the latest version of the transactional information available which affects only those passengers currently on that particular airplane. Passengers are identified by the boarding pass security code (for example), and that key can be associated with the itinerary trip record locator and trip ID value which is commonly associated with an individual traveler for a single-leg or multiple-leg flights.

Updates to the transactional information are broadcast from the destination airport (or other communication systems en route) through a network (e.g., the Internet 112) to the flight on a periodic basis (e.g., approximately every five minutes), with this information made available to passengers through one or more passenger accessible input/output devices such as personal communication devices 113 (e.g., a passenger's cell phone or PDA), overhead displays of the airplane or personal airplane seat displays 114 such as those offered as a standard feature of JetBlue™ coach and first-class flights. Where individual seat displays are available, infrastructure and personal information received by the airplane-based server 108 is routed to the display 114 at the designated seat 116 of the individual passengers, such as through a communication bus 118. The information access may optionally be offered for sale as a premium service.

Where individual seat displays 114 are further equipped with interactive touch-screen interfaces, passengers may request certain tailored information reports from a menu 120 of options. Requests for particular queries are gathered in an airplane client application system executed by the airplane server 108 and subsequently transmitted to the logistics coordination centers on the ground on a real-time basis or, alternatively, in batches of transactions periodically sent. Responses to the customized information queries requested are returned as the information becomes available, or during the regular periodic updates sent approximately every five minutes. If information is received which affects a particular passenger, an alert may be sounded or displayed at the passenger's personal display system which would eliminate the need for flight assistant personnel to notify the passenger in person, read any individual announcements, or involve themselves in any aspect of transmitting information to one or more passengers.

In summary of the exemplary information system embodiment 100, the airport server 104 sends information via the Internet 112 to the airplane server 108, which then sends the information to the airplane seat screens 114. At each airplane seat screen 114, the passengers may query information and deal with schedule changes, cancellations and delays by rescheduling flights. In addition, missing or late baggage may also be dealt with in the plane, for example, by bypassing waiting for luggage at the terminal that will not arrive. Information input via airplane screens 114 is received by airplane server 108 and then forwarded to the airport server 104 via the Internet 112. The airport server 104 may also send information via the Internet 112 to cell phone/PDA 113 before takeoff and after landing.

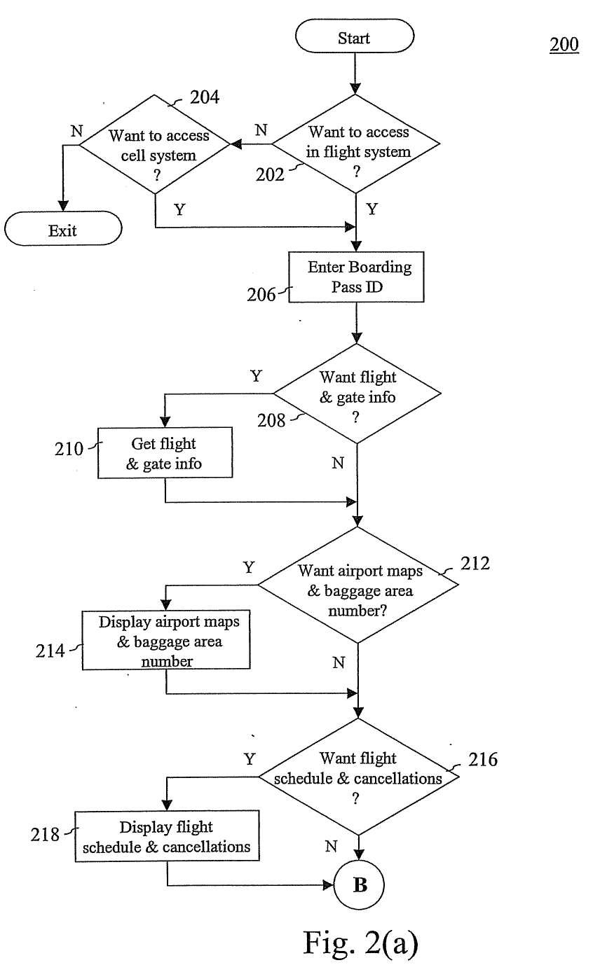

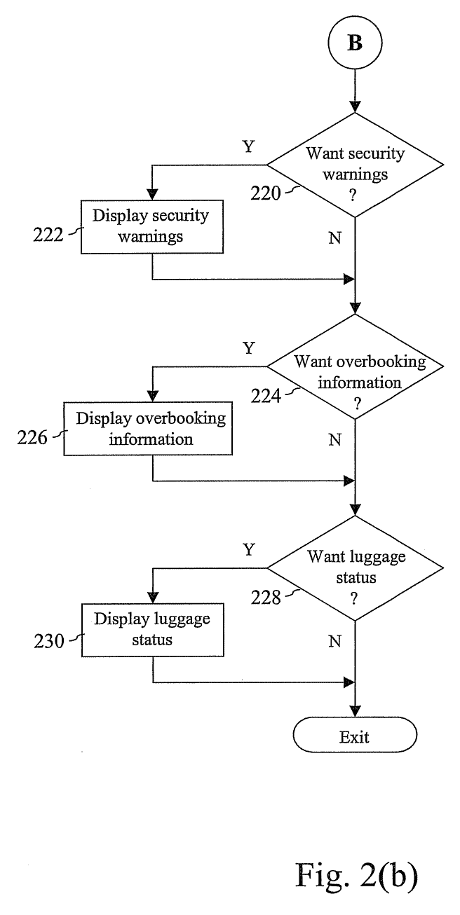

Referring now to FIGS. 2(a) and 2(b), there is shown a flow diagram illustrating a method 200 for operating an in-flight passenger information system, in accordance with a further embodiment of the invention. As shown at decision blocks 202 and 204 of FIG. 2(a), if a passenger wishes to either access the information system through the in-flight system through the airplane hardware or the passenger's own communication device, the method proceeds to block 206 where the passenger enters a unique identifier, such as the boarding pass ID number, for example. Once the ID is entered into the in-flight system onboard the aircraft or into a wireless communication device, the passenger may selectively retrieve personalized information as described above. For example, decision block 208 and block 210 access flight and gate information for continuing flights. In decision block 212 and block 214, the passenger may access airport maps and baggage claim area numbers for display. In decision block 216 and block 218, the passenger may access and display general flight schedule information and flight cancellations.

Continuing to FIG. 2(b), the passenger may access and display any applicable security warnings for the arrival airport(s) as shown in decision block 220 and block 222. In decision block 224 and block 226, the passenger may access and display overbooking information and airline incentives in the event the passenger decides to take a later connecting flight. Finally, in decision block 228 and block 230, the passenger may access and display the status/location of any checked baggage. For example, the location information may confirm whether the baggage is actually on the same flight as the passenger, whether it is sitting in an airport or whether it is scheduled to be forwarded to the final destination airport on a subsequent flight. As will be appreciated, however, other types of information that may be of interest to a specific passenger (not specifically mentioned above) may also be included as part of the exemplary system and method embodiments described herein.

In view of the above, the present method embodiments may therefore take the form of computer or controller implemented processes and apparatuses for practicing those processes. The disclosure can also be embodied in the form of computer program code containing instructions embodied in tangible media, such as floppy diskettes, CD-ROMs, hard drives, or any other computer-readable storage medium, wherein, when the computer program code is loaded into and executed by a computer or controller, the computer becomes an apparatus for practicing the invention.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for implementing an in-flight passenger information system, comprising:
one or more ground-based servers in network communication with an airplane-based server, the one or more ground-based servers configured to execute a computer application for accessing a database containing airport infrastructure information and passenger transactional information; and
the airplane-base server in communication with one or more passenger accessible input/output devices;
wherein the one or more passenger accessible input/output devices are configured to communicate to a passenger, while onboard an airplane, passenger-selected portions of the airport infrastructure information and passenger transactional information specific to the passenger.

2. The system of claim 1, wherein the airport infrastructure information includes one or more of: airport terminal layouts and default flight schedules.

3. The system of claim 1, wherein the passenger transactional information includes one or more of: passenger identification, trip continuation flight legs, gate information for connecting flights, baggage claim information, local weather information, flight schedule changes, cancellations and delays, security warnings, and overbooking premium opportunities.

4. The system of claim 1, wherein the one or more ground-based servers communicates updates of the passenger transactional information to the airplane-based server on a periodic basis.

5. The system of claim 4, wherein the airplane-based server communicates passenger generated queries to the one or more ground-based servers on a real-time basis.

6. The system of claim 4, wherein the airplane-based server communicates passenger generated queries to the one or more ground-based servers in batches of transactions generated on a periodic basis.

7. The system of claim 1, wherein the one or more passenger accessible input/output devices comprise one or more of: personal communication devices, overhead displays of the airplane, and personal airplane seat displays.

8. The system of claim 1, wherein the passenger transactional information specific to the passenger is accessed through the one or more passenger accessible input/output devices by entry of a boarding pass ID specific to the passenger.

9. A computer program product, comprising:
a computer readable computer program code for implementing a method of accessing and operating an in-flight passenger information system; and
instructions for causing a computer to implement a method, the method further comprising:
receiving a request for one or more of airport infrastructure information and passenger transactional information specific to a passenger onboard an airplane, the request being input by the passenger via one or more passenger accessible input/output devices;
accessing, through one or more ground-based servers in network communication with an airplane-based server, a database containing the airport infrastructure information and the passenger transactional information; and
communicating the requested information to the onboard passenger, received by the airplane-based server, through the one or more passenger accessible input/output devices.

10. The computer program product of claim 9, wherein the airport infrastructure information includes one or more of: airport terminal layouts and default flight schedules.

11. The computer program product of claim 9, wherein the passenger transactional information includes one or more of: passenger identification, trip continuation flight legs, gate information for connecting flights, baggage claim information, local weather information, flight schedule changes, cancellations and delays, security warnings, and overbooking premium opportunities.

12. The computer program product of claim 9, wherein the one or more ground-based servers communicates updates of the passenger transactional information to the airplane-based server on a periodic basis.

13. The computer program product of claim 12, wherein the airplane-based server communicates passenger generated queries to the one or more ground-based servers on a real-time basis.

14. The computer program product of claim 12, wherein the airplane-based server communicates passenger generated queries to the one or more ground-based servers in batches of transactions generated on a periodic basis.

15. The computer program product of claim 9, wherein the one or more passenger accessible input/output devices comprise one or more of: personal communication devices, overhead displays of the airplane, and personal airplane seat displays.

16. The computer program product of claim 9, wherein the passenger transactional information specific to the passenger is accessed through the one or more passenger accessible input/output devices by entry of a boarding pass ID specific to the passenger.
